(19) United States
(12) Patent Application Publication
(10) Pub. No.: US 2025/0045861 A1
(43) Pub. Date: Feb. 6, 2025

(54) SYSTEM AND METHOD FOR ADDING COPYRIGHT PROTECTION TO IMPLICIT 3D MODEL

(71) Applicant: Hong Kong Baptist University, Hong Kong (HK)

(72) Inventors: Renjie WAN, Hong Kong (HK); Ziyuan LUO, Hong Kong (HK)

(21) Appl. No.: 18/670,740

(22) Filed: May 22, 2024

Related U.S. Application Data
(60) Provisional application No. 63/517,655, filed on Aug. 4, 2023.

(51) Int. Cl. G06T 1/00; G06T 17/20; G06T 19/20

(52) U.S. Cl. CPC G06T 1/005; G06T 17/20; G06T 19/20; G06T 2201/0051; G06T 2201/0064; G06T 2201/0065; G06T 2219/2012

(57) ABSTRACT

A system for adding copyright protection to implicit 3D models is provided. The system includes a first MLP module, a second MLP module, a color feature encoder, a message feature encoder, and a feature fusion module. The first MLP module outputs a geometry parameter according to a 3D coordinate parameter obtained from a 3D model source. The second MLP module outputs a base-colors parameter according to a viewing-directions parameter obtained from the 3D model source and outcomes of the first MLP module. The color feature encoder concatenates the geometry parameter, the viewing-directions parameter, and the base-colors parameter to obtain a spatial descriptor and transforms the spatial descriptor to a high-dimensional color feature field. The message feature encoder maps messages to higher dimensions so as to obtain a message feature field. The feature fusion module generates a watermarked color representation and embed the watermarked color representation into the 3D model source.

### CROSS-REFERENCE TO RELATED APPLICATIONS

The present application claims priority from U.S. provisional patent application Ser. No. 63/517,655 filed Aug. 4, 2023, and the disclosures of which are incorporated by reference in their entireties.

### TECHNICAL FIELD

The present invention relates to copyright protection techniques, and particularly to copyright protection for neural radiance fields (NeRF) models.

### BACKGROUND

While Neural Radiance Fields (NeRF) have the potential to become mainstream for representing digital media, training a NeRF model has never been an easy task. If an implicit 3D model built by NeRF is stolen by malicious users, how can we identify its intellectual property? Accordingly, this is an issue for 3D models built by NeRF.

As with any digital asset (e.g., 3D models, videos, or images), copyright can be secured by embedding copyright messages into assets, called digital watermarking, and NeRF models are no exception. An intuitive solution is to directly watermark rendered samples using an off-the-shelf watermarking approach (e.g., HiDDeN and MBRS). However, this only protects the copyright of rendered samples, leaving the core model unprotected. If the core model has been stolen, malicious users may render new samples using different rendering strategies, leaving no room for external watermarking expected by model creators. Besides, without considering factors necessary for rendering during watermarking, directly watermarking rendered samples may leave easily detectable trace on areas with low geometry values.

The copyright messages are usually embedded into 3D structure (e.g., meshes) for explicit 3D models. Since such structures are all implicitly encoded into the weights of multilayer perceptrons (MLP) for NeRF, its copyright protection should be conducted by watermarking model weights. As the information encoded by NeRF can only be accessed via 2D renderings of protected models, two common standards should be considered during the watermark extraction on rendered samples: (1) invisibility, which requires that no serious visual distortion are caused by embedded messages, and 2) robustness, which ensures robust message extraction even when various distortions are encountered.

One option is to create a NeRF model using watermarked images, while the popular invisible watermarks on 2D images cannot be effectively transmitted into NeRF models. FIG. 1 shows reconstruction quality under different settings. When NeRF models are stolen (e.g., at the label “1”) by malicious users, CopyRNeRF can help to claim model ownership by transmitting copyright messages embedded in models to rendering samples (e.g., at the label “1”). There are some comparisons with HiD-DeN+NeRF, and NeRF with messages. PSNR/Bit Accuracy is shown as well. In FIG. 1, with respect to HiDDeN+NeRF, although the rendered results are of high quality, the secret messages cannot be robustly extracted. It is possible to directly concatenate secret messages with input coordinates, which produces higher bit accuracy (NeRF with message in FIG. 1). However, the lower PSNR values of rendered samples indicate that there is an obvious visual distortion, which violates the standard for invisibility.

Therefore, in order to achieve improvements in the copyright protection for NeRF 3D models, there is a need for enhanced systems and methods of verifying and protecting intellectual property associated with implicit NeRF 3D models.

### SUMMARY OF INVENTION

It is an objective of the present invention to provide systems and methods to address the aforementioned shortcomings and unmet needs in the state of the art.

Neural Radiance Fields (NeRF) have the potential to be a major representation of media. Since training a NeRF has never been an easy task, the protection of its model copyright should be a priority. In the present disclosure, by analyzing the pros and cons of possible copyright protection solutions, we propose to protect the copyright of NeRF models by replacing the original color representation in NeRF with a watermarked color representation. Then, a distortion-resistant rendering scheme is designed to guarantee robust message extraction in 2D renderings of NeRF. The provided method of the present invention can directly protect the copyright of NeRF models while maintaining high rendering quality and bit accuracy when compared among optional solutions.

Although invisibility is important for a watermarking system, the higher demand for robustness makes watermarking unique. Thus, in addition to invisibility, it is to focus on a more robust protection of NeRF models. As opposed to embedding messages into the entire models as afore-mentioned, in the present invention, the proposed solution is to create a watermarked color representation for rendering based on a subset of models. By keeping the base representation unchanged, this approach can produce rendering samples with invisible watermarks. By incorporating spatial information into the watermarked color representation, the embedded messages can remain consistent across different viewpoints rendered from NeRF models. It further strengthens the robustness of watermark extraction by using distortion-resistant rendering during model optimization. A distortion layer is designed to ensure robust watermark extraction even when the rendered samples are severely distorted (e.g., blurring, noise, and rotation). A random sampling strategy is further considered to make the protected model robust to different sampling strategy during rendering.

In one embodiment, distortion-resistant rendering is only needed during the optimization of core models. If the core model is stolen, even with different rendering schemes and sampling strategies, the copyright message can still be robustly extracted.

In accordance with a first aspect of the present invention, a system for adding copyright protection to implicit 3D models is provided. The system includes a first MLP module, a second MLP module, a color feature encoder, a message feature encoder, and a feature fusion module. The first MLP module is configured to output a geometry parameter according to a 3D coordinate parameter obtained from a 3D model source. The second MLP module is configured to output a base-colors parameter according to a viewing-directions parameter obtained from the 3D model source and according to outcomes of the first MLP module. The color feature encoder is configured to concatenate the geometry parameter, the viewing-directions parameter, and the base-colors parameter to obtain a spatial descriptor and further configured to transform the spatial descriptor to a high-dimensional color feature field. The message feature encoder is configured to map messages to higher dimensions so as to obtain a message feature field. The feature fusion module is configured to generate a watermarked color representation and embed the watermarked color representation into the 3D model source.

In accordance with a second aspect of the present invention, a method for adding copyright protection to implicit 3D models is provided. The method includes steps as follows: generating, by a first MLP module, a geometry parameter according to a 3D coordinate parameter obtained from a 3D model source; generating, by a second MLP module, a base-colors parameter according to a viewing-directions parameter obtained from the 3D model source and according to outcomes of the first MLP module; concatenating, by a color feature encoder, the geometry parameter, the viewing-directions parameter, and the base-colors parameter to obtain a spatial descriptor; transforming, by the color feature encoder, the spatial descriptor to a high-dimensional color feature field; mapping, by a message feature encoder, messages to higher dimensions so as to obtain a message feature field; and generating a watermarked color representation and embedding the watermarked color representation into the 3D model source by a feature fusion module.

The provided solution can be summarized as follows: a method to produce copyright-embedded NeRF models; a watermarked color representation to ensure invisibility and high rendering quality; and distortion-resistant rendering to ensure robustness across different rendering strategies or 2D distortions.

### BRIEF DESCRIPTION OF DRAWINGS

Embodiments of the invention are described in more details hereinafter with

FIG. 1 shows reconstruction quality under different settings;

FIG. 2 depicts a schematic drawing for a network architecture of a system according to one embodiment of the present invention;

FIG. 3 depicts a schematic drawing of a method for adding copyright protection to implicit 3D models using the system according to one embodiment of the present invention;

FIG. 4 shows differences between synthesized results and ground truth;

FIG. 5 shows results of analysis for failure of MBRS+NeRF;

FIG. 6 shows results for different sampling schemes for comparisons for different rendering degradation;

FIG. 7 shows comparisons for watermarking after rendering;

FIG. 8 shows that, when directly watermarking synthesized 2D images with novel views, the model weights are not protected;

FIG. 9 shows workflow of the provided solution;

FIG. 10 shows qualitative results; and

FIG. 11 shows qualitative evaluations.

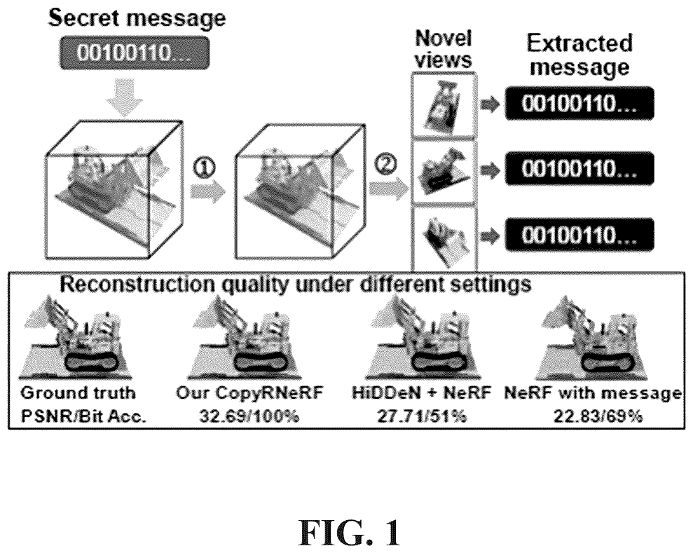

### DETAILED DESCRIPTION OF THE INVENTION

In the following description, system and method for adding copyright protection to implicit 3D model and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

In order to make the technical content of the present disclosure easier to understand, related work is provided herein.

### (I) Related Work

Regarding neural radiance fields, various neural implicit scene representation schemes have been introduced recently. The Scene Representation Networks (SNR) represent scenes as a multi-layer perceptron (MLP) that maps world coordinates to local features, which can be trained from 2D images and their camera poses. DeepSDF and DIST use trained networks to represent a continuous signed distance function of a class of shapes. PIFu learned two pixel-aligned implicit functions to infer surface and texture of clothed humans respectively from a single input image. Occupancy Networks are proposed as an implicit representation of 3D geometry of 3D objects or scenes with 3D supervision. NeRF in particular directly maps the 3D position and 2D viewing direction to color and geometry by a MLP and synthesize novel views via volume rendering. The improvements and applications of this implicit representation have been rapidly growing in recent years, including NeRF accelerating, sparse reconstruction, and generative models. NeRF models are not easy to train and may use private data, so protecting their copyright becomes crucial.

Regarding digital watermarking for 2D, early 2D watermarking approaches encode information in the least significant bits of image pixels. Some other methods instead encode information in the transform domains. Deep learning-based methods for image watermarking have made substantial progress. HiDDeN is one of the first deep image watermarking methods that achieved superior performance compared to traditional watermarking approaches. RedMark introduces residual connections with a strength factor for embedding binary images in the transform domain. Deep watermarking has since been generalized to video as well. Modeling more complex and realistic image distortions also broaden the scope in terms of application. However, those methods all cannot protect the copyright of 3D models.

Regarding digital watermarking for 3D, traditional 3D watermarking approaches leveraged Fourier or wavelet analysis on triangular or polygonal meshes. Recently, some works introduce a 3D watermarking method using the layering artifacts in 3D printed objects. Some works use mesh saliency as a perceptual metric to minimize vertex distortions. Some works further extend mesh saliency with wavelet transform to make 3D watermarking robust. Some works study watermarking for point clouds through analyzing vertex curvatures. Recently, a deep-learning-based approach successfully embeds messages in 3D meshes and extracts them from 2D renderings. However, the existing methods are for explicit 3D models, which cannot be used for NeRF models with implicit property.

Some preliminary works are provided as parameter definition for the proposed solution.

### (II) Preliminaries

NeRF uses Multilayer Perceptrons (MLPs) Θ_{σ} and Θ_{c} to map the 3D location x∈R³ and viewing direction d∈R² to a color value c∈R³ and a geometric value σ∈R⁺:

$$[ σ , z ] = {Θ}_{σ} ( {γ}_{x} ( x ) ) \qquad ( 1 )$$

$$c = {Θ}_{c} ( z , {γ}_{d} ( d ) ) \qquad ( 2 )$$

where γₓ and γ_{d} are fixed encoding functions for location and viewing direction respectively. The intermediate variable z is a feature output by the first MLP Θ_{σ}.

For rendering a 2D image from the radiance fields Θ_{σ} and Θ_{c}, a numerical quadrature is used to approximate the volumetric projection integral. Formally, Nₚ points are sampled along a camera ray r with color and geometry values {(cᵣⁱ,σᵣⁱ)}ᵢ₌₁^{N}. The RGB color value Ĉ(r) is obtained using alpha composition:

$$\hat{C} ( r ) = {\sum }_{i = 1}^{{N}_{p}} {T}_{r}^{i} ( 1 - exp ( - {σ}_{r}^{i} {δ}_{r}^{i} ) ) {c}_{r}^{i} \qquad ( 3 )$$

Where Tᵣⁱ=Πⱼ₌₁ⁱ⁻¹(exp(−σᵣⁱδᵣⁱ)), and δᵣⁱ is the distance between adjacent sample points. The MLPs Θ_{σ} and Θ_{c} are optimized by minimizing a reconstruction loss between observations C and predictions Ĉ as

$${ℒ}_{r e c o n} = \frac{1}{{N}_{r}} {\sum }_{m = 1}^{{N}_{r}} {‖ \hat{C} ( {r}_{m} ) - C ( {r}_{m} ) ‖}_{2}^{2} \qquad ( 4 )$$

where Nᵣ is the number of sampling pixels. Given Θ_{σ} and Θ_{c}, novel views can be synthesized by invoking volume rendering for each ray.

Considering the superior capability of NeRF in rendering novel views and representing various scenes, there is an issue to be solved: how can we protect its copyright when it is stolen by malicious users?

To solve the issue, in the present disclosure, a system and method for adding copyright protection to implicit 3D models are provided.

### (III) System and Method for Adding Copyright Protection to Implicit 3D Models

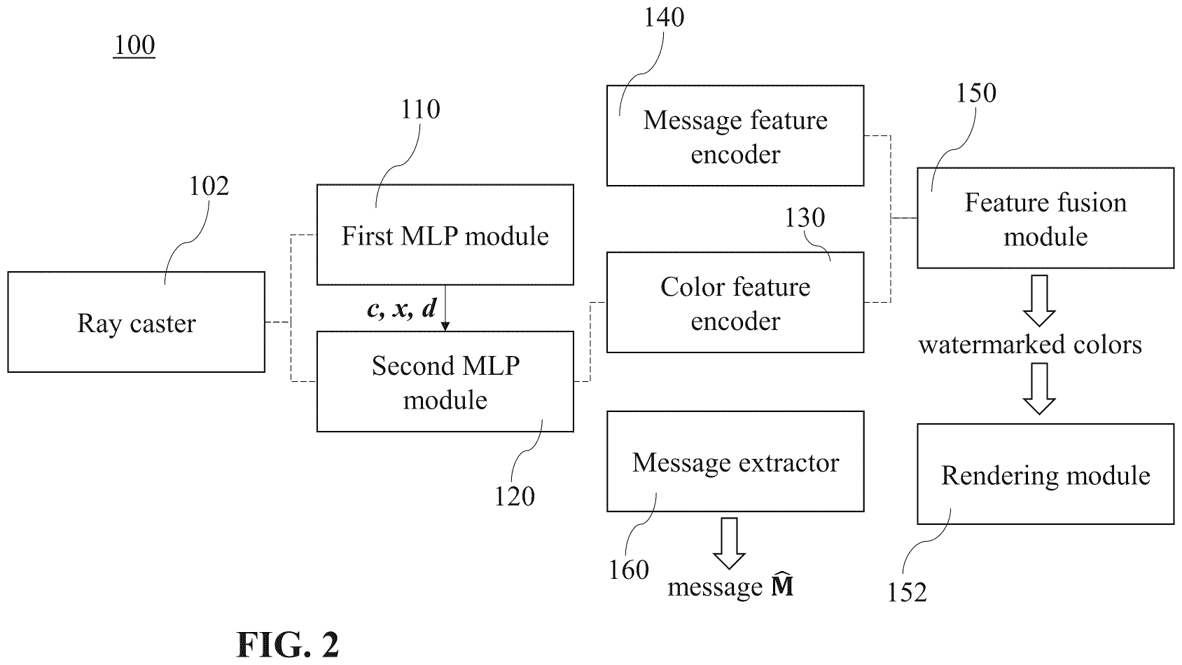

FIG. 2 depicts a schematic drawing for a network architecture of a system 100 according to one embodiment of the present invention. The system 100 with the network architecture is provided to make adding copyright protection to implicit 3D models effective and robust. That is, by applying the system 100, the purpose for copyright protection operated by a processor or a computer is to significantly reduce computer power consumption and speed up computational processes. This is achieved through the provided model or method and is to maximize computational efficiency, resulting in accelerated operations and reduced energy consumption.

The system 100 is provided for adding copyright protection to implicit 3D models and includes a network architecture. The system 100 with the network architecture includes a ray caster 102, a first MLP module 110, a second MLP module 120, a color feature encoder 130, a message feature encoder 140, a feature fusion module 150, and a message extractor 160. Those components may be achieved by using MLPs function.

The ray caster 102 is configured to emit at least one ray from a sampling point to provide propagation of light in a scene. It can detect intersections with targeted objects, determining color values based on scene geometry and lighting. As such, the ray caster 102 generates images by collecting color values of intersection points.

The first MLP module 110, equipped with 256 channels, is configured to map a position profile captured from the ray caster 102 (e.g., coordinates x from a 3D model source/image) to generate geometry values and an intermediate feature for medium generation. The second MLP module 120 is configured to output base colors c (i.e., a base-colors parameter) based on the outcomes of the ray caster 102 and the first MLP module 110 and further based on viewing directions d captured from the ray caster 102.

The color feature encoder 130, the message feature encoder 140, and the feature fusion module 150 are collectively configured to process building watermarked color representation. The color feature encoder 130 is a three-layer MLP configured to embed base colors c (i.e., a base-colors parameter) queried from the second MLP module 120, coordinates x, and viewing directions d captured from the ray caster 102 to 256-dimensional color features. The message feature encoder 140 is a two-layer MLP configured to extract features from input messages. The feature fusion module 150 is realized by a three-layer MLP configured to generate a watermarked color from a color feature field and a message feature field and further configured to embed the watermarked color into a targeted 3D model (i.e., which is captured or obtained by using the ray caster 102). In this regard, the color feature field and the message feature field refer to data structures or feature representations used to describe color and message features, respectively. The color feature field may include information about the colors of individual pixels in an image, while the message feature field may contain information about hidden messages within the image. In the feature fusion module 150, these feature fields are combined to generate watermarked colors.

The message extractor 160 includes a convolutional neural network (CNN)-based structure. In the message extractor 160, a convolutional layer, a normalization layer, and a relu activation function are combined as a base block. The message extractor 160 further includes a pooling layer and a linear layer. The message extractor 160 contains 7 base blocks with 64 filters each and one last block with N_{b} filters, where N_{b} is the length of message. The pooling layer is configured to get the average of each dimension, and the linear layer is configured to produce the final extracted message \hat{M} with the dimension N_{b}.

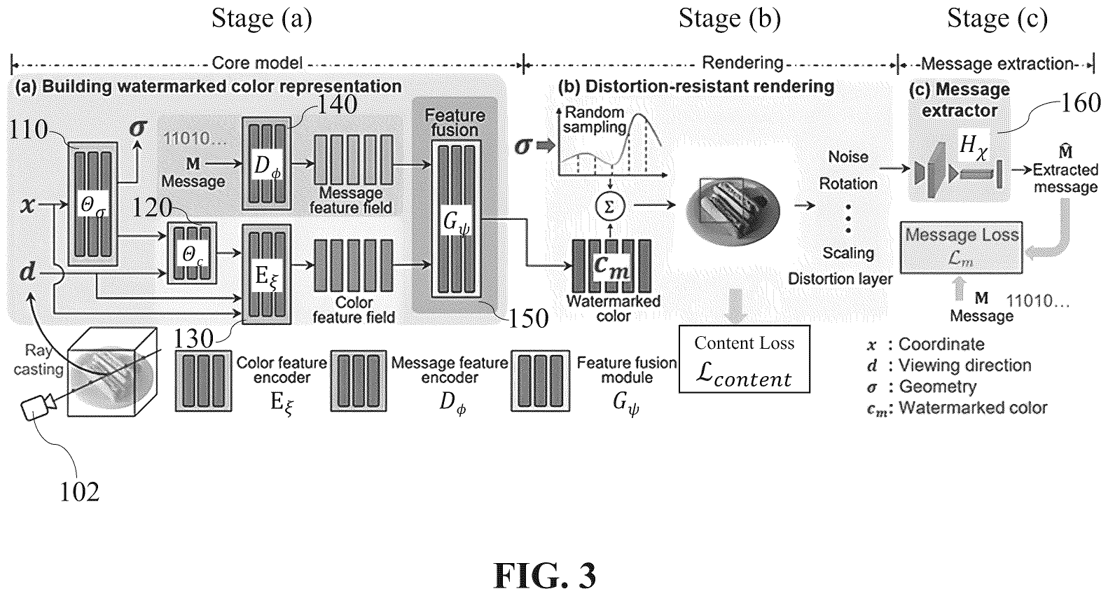

FIG. 3 depicts a schematic drawing of a method for adding copyright protection to implicit 3D models using the system 100 according to one embodiment of the present invention. Briefly, there are three stages, including (a) core model: a watermarked color representation is obtained with the given secret message, which is able to produce watermarked color for rendering; (b) rendering: during training, a distortion-resistant rendering is deployed to map the geometry σ and watermarked color representations to image patches with several distortions; and (c) message extraction: finally, the secret message can be revealed by a CNN-based message extractor.

As shown in FIG. 3, with a collection of 2D images {Iₙ}ₙ₌₁^{N} and the binary message M∈{0,1}^{Nb} with length N_{b}, it addresses the afore-mentioned issue by building a watermarked color representation during optimization. In training, a distortion-resistant rendering is further applied to improve the robustness when 2D distortions or different rendering schemes are encountered. With the above design, the secret messages can be robustly extracted during testing even encountering sever distortions or different rendering strategies.

In the following stage: the symbol Θₘ represents the first MLP module 110; Θ_{c} represents the second MLP module 120; the symbol E_{ξ} represents the color feature encoder 130; the symbol De represents the message feature encoder 140; the symbol G_{ψ} represents the feature fusion module 150; and the symbol H_{χ} represents the message extractor 160.

### Stage (a): Building Watermarked Color Representation

The rendering in Equation (3) relies on color and geometry produced by their corresponding representation in NeRF. To ensure the transmission of copyright messages to the rendered results, it is to propose embedding messages into their representation. A watermarked color representation is created on the basis of Θ_{c} defined in Equation (2) to guarantee the message invisibility and consistency across viewpoints. The representation of geometry is also the potential for watermarking, but external information on geometry may undermine rendering quality. Therefore, the geometry does not become our first option, while experiments are also conducted to verify this setting.

The geometry representation in Equation (1) is kept unchanged, and construct the watermarked color representation Θₘ to produce the message embedded color cₘ as follows:

$${c}_{m} = {Θ}_{m} ( c , {γ}_{x} ( x ) , {γ}_{d} ( d ) , M ) \qquad ( 5 )$$

where M denotes the message to be embedded and Θₘ contains several MLPs to ensure reliable message embedding. The input c is obtained by querying Θ_{c} using Equation (2). Several previous methods have pointed out the importance of building a 3D feature field when distributed features are needed to characterize composite information. Thus, instead of directly fusing those information, the first is to construct their corresponding feature field and then combine them progressively.

Regarding, color feature field, in this stage, it is to aim at fusing the spatial information and color representation to ensure message consistency and robustness across viewpoints. It is to adopt a color feature field by considering color, spatial positions, and viewing directions simultaneously as follows:

$${f}_{c} = {E}_{ξ} ( c , {γ}_{x} ( x ) , {γ}_{d} ( d ) ) \qquad ( 6 )$$

Given a 3D coordinate x and a viewing direction d (e.g., captured or obtained from the ray caster 102), the first is to query the color representation Θ_{c}(z,γ_{d}(d)) to get c, and then, it is to concatenate them with x and d to obtain spatial descriptor v as the input. Next, the color feature encoder E_{ξ} transforms v to the high-dimensional color feature field f_{c} with dimension N_{c}. The Fourier feature encoding is applied to x and d before the feature extraction.

Regarding message feature field, specifically, it follows the classical setting in digital watermarking by transforming secret messages into higher dimensions. It ensures more succinctly encoding of desired messages. As shown in FIG. 3, a message feature encoder is applied to map the messages to its corresponding higher dimensions as follows:

$${f}_{M} = {D}_{ϕ} ( M ) \qquad ( 7 )$$

In Equation (7), given message M of length N_{b}, the message feature encoder D_{ϕ} applies a MLP to the input message, resulting in a message feature field f_{M} of dimension Nₘ.

Then, the watermarked color can be generated via a feature fusion module G_{ψ} that integrates both color feature field and message feature field as follows:

$${c}_{m} = G ψ ( fc , fM , c ) \qquad ( 8 )$$

Specifically, c is also employed here to make the final results more stable. cₘ is with the same dimension to c, which ensures this representation can easily adapt to current rendering schemes.

### Stage (b): Distortion-Resistant Rendering

Directly employing the watermarked representation for volume rendering has already been able to guarantee invisibility and robustness across viewpoints. However, as previously discussed, the message should be robustly extracted even when encountering diverse distortion to the rendered 2D images. Besides, for an implicit model relying on rendering to display its contents, the robustness should also be secured even when different rendering strategies are employed. Such requirement for robustness cannot be achieved by simply using watermarked representation under the classical NeRF training framework. For example, the pixel-wise rendering strategy cannot effectively model the distortion (e.g., blurring and cropping) only meaningful in a wider scale. Therefore, it is to propose a distortion-resistant rendering by strengthening the robustness using a random sampling strategy and distortion layer.

Since most 2D distortions can only be obviously observed in a certain area, the rendering process in a patch level is considered. A window with the random position is cropped from the input image with a certain height and width, then the pixels are uniformly sampled from such window to form a smaller patch. The center of the patch is denoted by u=(u,v)∈R², and the size of patch is determined by K∈R⁺. The patch center u is randomly drawn from a uniform distribution u˜U(Ω) over the image domain Ω. The patch P(u,K) can be denoted by a set of 2D image coordinates as:

$$𝒫 ( u , K ) = \{ ( x + u , y + v ) \vert x , y ∈ \{ - \frac{K}{2} , … , \frac{K}{2} - 1 \} \} \qquad ( 9 )$$

Such a patch-based scheme constitutes the backbone of the provided distortion-resistant rendering, due to its advantages in capturing information on a wider scale. Specifically, a variable patch size is employed to accommodate diverse distortions during rendering, which can ensure higher robustness in message extraction. This is because small patches increase the robustness against cropping attacks and large patches allow higher redundancy in the bit encoding, which leads to increased resilience against random noise.

As the corresponding 3D rays are uniquely determined by P(u,K), the camera pose and intrinsics, the image patch Pₑ can be obtained after points sampling and rendering. Based on the sampling points mentioned in (II) Preliminaries, it is to use a random sampling scheme to further improve the model's robustness, which is described as follows.

### Random Sampling:

During volume rendering, NeRF is required to sample 3D points along a ray to calculate the RGB value of a pixel color. However, the sampling strategy may vary as the renderer changes. To make the message extraction more robust even under different sampling strategies, a random sampling strategy is employed by adding a shifting value to the sampling points. Specifically, the original Nₚ sampling points along ray r is denoted by a sequence, which can be concluded as χ=(xᵣ¹, xᵣ², . . . xᵣ^{N}^{ₚ}), where xᵣⁱ, i=1, 2, . . . , Nₚ denotes the sampling points during rendering. The randomized sample sequence X_{random} can be denoted by adding a shifting value as:

$${χ}_{r a n d o m} = ( {x}_{r}^{1} + {z}^{1} , {x}_{r}^{2} + {z}^{2} , … , {x}_{r}^{{N}_{p}} + {z}^{{N}_{p}} ) \vert ; {z}^{i} ∼ 𝒩 ( 0 , {β}^{2} ) , i = 1 , 2 , … , {N}_{p} \qquad ( 9 )$$

where [symbol] (0,β²) is the Gaussian distribution with zero mean and standard deviation β.

By querying the watermarked color representation and geometry values at Nₚ points in X_{random}, the rendering operator can be then applied to generate the watermarked color Ĉₘ in rendered images:

$${\hat{C}}_{m} ( r ) = {\sum }_{i = 1}^{{N}_{p}} {T}_{r}^{i} ( 1 - exp ( - {σ}_{r}^{i} {δ}_{r}^{i} ) ) {c}_{m}^{i} \qquad ( 11 )$$

where Tᵣⁱ and δᵣⁱ are with the same definitions to their counterparts in Equation (3).

All the colors obtained by coordinates P can form a K×K image patch \tilde{P}. The content loss L_{content} of the 3D representation is calculated between watermarked patch \tilde{P} and the \hat{P}, where \hat{P} is rendered from the non-watermarked representation by the same coordinates P. In detail, the content loss L_{content} has two components namely pixel-wise MSE loss and perceptual loss:

$${ℒ}_{content} = {‖ \tilde{P} - \hat{P} ‖}_{2}^{2} + λ {‖ Ψ ( \tilde{P} ) - Ψ ( \hat{P} ) ‖}_{2}^{2} \qquad ( 12 )$$

where Ψ(·) denotes the feature representation obtained from a VGG-16 network, and λ is a hyperparameter to balance the loss functions.

In one embodiment, the system 100 may include a rendering module 152 to execute the stage (b) for rendering. In one embodiment, the rendering module 152 is configured to query the watermarked color representation and geometry values at Nₚ points in X_{random}, so it can make the rendering operator applied to generation for the watermarked color Ĉₘ in rendered images. The system 100 may further includes a distortion layer. To make the watermarking system robust to 2D distortions, a distortion layer is employed in the watermarking training pipeline after the patch \tilde{P} is rendered. Several commonly used distortions are considered: 1) additive Gaussian noise with mean μ and standard deviation v; 2) random axis-angle rotation with parameters α; and 3) random scaling with a parameter s; 4) Gaussian blur with kernel k. Since all these distortions are differentiable, the network could be trained as being end-to-end.

In one embodiment, the distortion-resistant rendering is only applied during training. It is not a part of the core model. If the core model is stolen, even malicious users use different rendering strategy, the expected robustness can still be secured.

In one embodiment, the system 100 further includes a display for displaying the 3D models without embedding the watermarked color representation and with embedding the watermarked color representation for comparison for users.

### Stage (c): Message Extraction

To retrieve message \hat{M} from the K×K rendered patch P, a message extractor H_{χ} is proposed to be trained end-to-end:

$${H}_{χ} : \to , P \to \hat{M} \qquad ( 13 )$$

where χ is a trainable parameter. Specifically, it is to employ a sequence of 2D convolutional layers with the batch normalization and ReLU functions. An average pooling is then performed, following by a final linear layer with a fixed output dimension N_{b}, which is the length of the message, to produce the continuous predicted message \hat{M}. Because of the use of average pooling, the message extractor is compatible with any patch sizes, which means the network structure can remain unchanged when applying size-changing distortions such as random scaling.

The message loss Lₘ is then obtained by calculating the mean square error between predicted message \hat{M} and the ground truth message M:

$${ℒ}_{m} = {‖ \hat{M} - M ‖}_{2}^{2} \qquad ( 14 )$$

To evaluate the bit accuracy during testing, the binary predicted message \hat{M}_{b} can be obtained by rounding:

$${\hat{M}}_{b} = clamp ( sign ( \hat{M} ) , 0 , 1 ) \qquad ( 15 )$$

where the definitions of clamp and sign are known in the field. It should be noted that the continuous result \hat{M} is used in the training process, while the binary one \hat{M}_{b} is only adopted in testing process.

Therefore, the overall loss to train the copyright-protected neural radiance fields can be obtained as:

$$ℒ = {γ}_{1} {ℒ}_{contest +} {γ}_{2} {ℒ}_{m} \qquad ( 16 )$$

where γ₁ and γ₂ are hyperparameters to balance the loss functions.

Furthermore, implementation details are provided. The provided method is implemented by using PyTorch. An eight-layer MLP with 256 channels and the following two MLP branches are used to predict the original colors c and opacities σ, respectively. A “coarse” network is trained along with a “fine” network for importance sampling. 32 points are sampled along each ray in the coarse model and 64 points in the fine model. Next, the patch size is set to 150×150. The hyperparameters in Equation (12) and Equation (16) are set as λ₁=0.01, γ₁=1, and λ₂=10.00. The Adam optimizer is used with defaults values β₁=0.9, β₂=0.999, ϵ=10⁻⁸, and a learning rate 5×10⁻⁴ that decays following the exponential scheduler during optimization is used as well. In the provided experiments, the setting for Nₘ in Equation (7) is 256. It is to first optimize MLPs Θ_{σ} and Θ_{c} using loss function Equation (4) for 200K and 100K iterations for Blender dataset and LLFF dataset separately, and then train the models E_{ξ}, D_{ϕ}, and H_{χ} on a single NVIDIA V100 GPU. During training, messages with different bit lengths and forms have been considered. If a message has 4 bits, it is to take into account all 2⁴ situations during training. The model creator can choose one message considered in our training as the desired message.

As such, the system 100 including the five MLPs (i.e., the first MLP module 110, the second MLP module 120, the color feature encoder 130, the message feature encoder 140, and the feature fusion module 150) and the CNN-based network (i.e., the message extractor 160) can achieve different purposes. The two MLPs Θ_{σ} and Θ_{c} (i.e., the first MLP module 110 and the second MLP module 120) are used to output the geometry σ and the colors c. The watermarked color representation module uses two MLPs, E_{ξ} and D_{ϕ} MLPs (i.e., the color feature encoder 130 and the message feature encoder 140), to obtain the color feature field and message feature field, respectively; and then the system 100 generates message representation by the feature fusion module G_{ψ} (i.e., the feature fusion module 150). The CNN-based message extractor H_{χ} (i.e., the message extractor 160) is employed to reveal the message from 2D rendered images.

The system is trained by a training process to re-fine parameters and get improved performance. In one embodiment, the training process involves machine-learning approaches. The training process includes three stages. In the first stage, the two MLPs Θ_{σ} and Θ_{c} (i.e., the first MLP module 110 and the second MLP module 120) are optimized to get geometry values of the scene according to L_{recon}. The second stage aims to learn a color feature encoder E_{ξ}, a message feature encoder De, and a feature fusion module G_{ψ} (i.e., the color feature encoder 130, the message feature encoder 140, and the feature fusion module 150) to build a watermarked color representation. Meanwhile, a message extractor H_{χ} (i.e., the message extractor 160) is trained to extract the message from the 2D images rendered by a distortion-resistant rendering module. In every training loop, a random camera pose in boundary and a random message M of dimension N_{b} are chosen. The content loss L_{content} is calculated by the rendered results from medium representation and message representation of the same camera pose. The message loss Lₘ is the mean squared error between embedded message M and the extracted message \hat{M}. The parameters {ξ,ϕ,ψ,χ} are optimized with the objective functions L_{content} and Lₘ. In the last training stage, the message extractor H_{χ} is finetuned with E_{ξ}, D_{ϕ}, and G_{ψ} frozen to further improve the bit accuracy.

In every training loop, all the messages in {0,1}^{Nb} have the same probability of being randomly selected, ensuring the consideration of all 2^{Nb} messages. When the model is prepared to be shared, a secret message M in {0,1}^{Nb} should be chosen by the model creator as the invisible copyright identity. The results show that the provided proposed CopyRNeRF can achieve a good balance between bit accuracy and error metric values.

### (IV) Experiments

Experimental results are provided to demonstrate that the system 100 is efficient.

### (IV-1) Experimental Settings

### Dataset

To evaluate our methods, it is to train and test the provided model on Blender dataset and LLFF dataset, which are common datasets used for NeRF. Blender dataset contains 8 detailed synthetic objects with 100 images taken from virtual cameras arranged on a hemisphere pointed inward. As in NeRF, for each scene we input 100 views for training. LLFF dataset consists of 8 real-world scenes that contain mainly forward-facing images. Each scene contains 20 to 62 images. The data split for this dataset also follows NeRF. For each scene, 20 images are selected from their testing dataset to evaluate the visual quality. For the evaluation of bit accuracy, 200 views are rendered for each scene to test whether the message can be effectively extracted under different viewpoints. Average values across all testing viewpoints in our experiments are reported.

### Baselines.

So far, there may not be the best method specifically for protecting the copyright of NeRF models yet. It is therefore to compare with four strategies to guarantee a fair comparison: 1) HiDDeN+NeRF: processing images with classical 2D watermarking method HiDDeN before training the NeRF model; 2) MBRS+NeRF: processing images with state-of-the-art 2D watermarking method MBRS before training the NeRF model; 3) NeRF with message: concatenating the message M with location x and viewing direction d as the input of NeRF; and 4) CopyRNeRF in geometry: changing our CopyRNeRF by fusing messages with the geometry to evaluate whether geometry is a good option for message embedding.

### Evaluation Methodology.

It is to evaluate the performance of the provided method against other methods by following the standard of digital watermarking about the invisibility, robustness, and capacity. For invisibility, the performance is evaluated by using PSNR, SSIM, and LPIPS to compare the visual quality of the rendered results after message embedding. For robustness, whether the encoded messages can be extracted effectively by measuring the bit accuracy on different distortions is investigated. Besides normal situations, the following distortions for message extraction are considered: 1) Gaussian noise, 2) Rotation, 3) Scaling, and 4) Gaussian blur. For capacity, following the setting in previous work for the watermarking of explicit 3D models, the invisibility and robustness under different message length as N_{b} ∈{4,8,16,32,48} are investigated, which has been proven effective in protecting 3D models. By incorporating various viewpoints in the experiments conducted, the evaluation aims to accurately assess the method's ability to maintain robustness and consistency across different perspectives.

### (IV-2) Experimental Results

### Qualitative Results

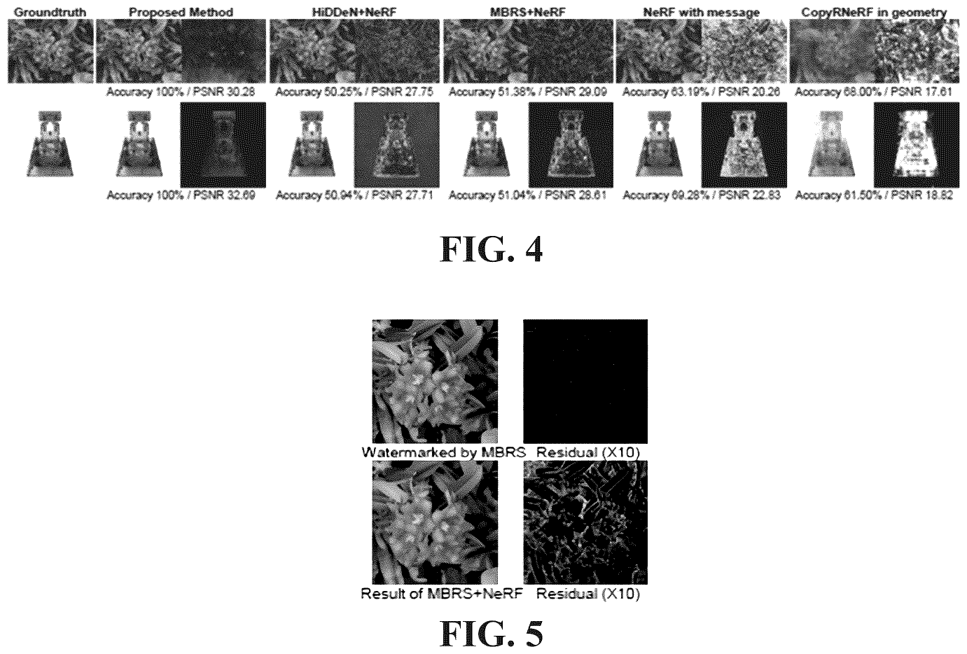

It is first to compare the reconstruction quality visually against all baselines and the results are shown in FIG. 4 with visual quality comparisons of each baseline. The illustration in FIG. 4 shows the differences (×10) between the synthesized results and the ground truth next to each method. The provided CopyRNeRF can achieve a well balance between the reconstruction quality and bit accuracy.

Actually, all methods except NeRF with message and CopyRNeRF in geometry can achieve high reconstruction quality. For HiDDeN+NeRF and MBRS+NeRF, although they are efficient approaches in 2D watermarking, their bit accuracy values are all low for rendered images, which proves that the message are not effectively embedded after NeRF model training. From the results shown in FIG. 5, which is analysis for failure of MBRS+NeRF, the view synthesis of NeRF changes the information embedded by 2D watermarking methods, leading to their failures. For NeRF with message, directly employing secret messages as an input change the appearance of the output, which leads to their lower PSNR values. Besides, its lower bit accuracy also proves that this is not an effective embedding scheme. For CopyRNeRF in geometry, it achieves the worst visual quality among all methods. The rendered results look blurred, which means the geometry is not a good option for message embedding.

Bit Accuracy vs. Message Length

There are 5 experiments for each message length and it is to show the relationship between bit accuracy and the length of message in Table 1:

TABLE 1
Bit accuracies with different lengths compared with
baselines; the results are averaged on all examples.

| | 4 bits | 8 bits | 16 bits | 32 bits | 48 bits |
|---|---|---|---|---|---|
| Provided | 100% | 100% | 91.16% | 78.08% | 60.06% |
| CopyRNeRF of | | | | | |
| the present | | | | | |
| invention | | | | | |
| HiDDen + NeRF | 50.31% | 50.25% | 50.19% | 50.11% | 50.04% |
| MBRS + NeRF | 53.25% | 51.38% | 50.53% | 49.80% | 50.14% |
| NeRF with | 72.50% | 63.19% | 52.22% | 50.00% | 51.04% |
| message | | | | | |
| CopyNeRf in | 76.75% | 68.00% | 60.16% | 54.86% | 53.36% |
| geometry | | | | | |

It is clear that the bit accuracy drops when the number of bits increases. However, the provided CopyRNeRF achieves the best bit accuracy across all settings, which proves that the messages can be effectively embedded and robustly extracted. CopyRNeRF in geometry achieves the second best results among all setting, which shows that embedding message in geometry should also be a potential option for watermarking. However, the higher performance of the provided CopyRNeRF shows that color representation is a better choice.

Bit Accuracy vs. Reconstruction Quality

More experiments are conducted to evaluate the relationship between bit accuracy and reconstruction quality. The results are shown in Table 2.

TABLE 2
Bit accuracies and reconstruction qualities compared with the
baselines; ↑(↓) means higher (lower) is better; it shows the
results on N_{b} = 16 bits; the results are averaged on
all example; and the best performances are highlighted in bold.

| | Bit Acc↑ | PSNR↑ | SSIM↑ | LPIPS↓ |
|---|---|---|---|---|
| Provided | 91.16% | 26.29 | 0.910 | 0.038 |
| CopyRNeRF of | | | | |
| the present | | | | |
| invention | | | | |
| HiDDen + NeRF | 50.19% | 26.53 | 0.917 | 0.035 |
| MBRS + NeRF | 50.53% | 28.79 | 0.925 | 0.022 |
| NeRF with | 52.22% | 22.33 | 0.773 | 0.108 |
| message | | | | |
| CopyNeRf in | 60.16% | 20.24 | 0.771 | 0.095 |
| geometry | | | | |

The provided CopyRNeRF achieves a good balance between bit accuracy and error metric values. Although the visual quality values are not the highest, the bit accuracy is the best among all settings. Although HiDDeN+NeRF and MBRS+NeRF can produce better visual quality values, its lower bit accuracy indicates that the secret messages are not effectively embedded and robustly extracted. NeRF with message also achieves degraded performance on bit accuracy, and its visual quality values are also low. It indicates that the embedded messages undermine the quality of reconstruction. Specifically, the lower visual quality values of CopyRNeRF in geometry indicates that hiding messages in color may lead to better reconstruction quality than hiding messages in geometry.

### Model Robustness on 2D Distortions.

The robustness of the provided method is evaluated by applying several traditional 2D distortions. Specifically, as shown in Table 3, several types of 2D distortions including noise, rotation, scaling, and cropping are considered.

TABLE 3
Bit accuracies with different distortion types compared with each baseline
and the provided CopyRNeRF without distortion-resistant rendering (DRR); it shows
the results on N_{b} = 16 bits; the results are averaged on all examples.

| | | | | | Gaussian |
|---|---|---|---|---|---|
| | | Gaussian | | | blur |
| | No | noise | Rotation | | (deviation = |
| | Distortion | (ν = 0.1) | (±π/6) | Scaling(≤25%) | 0.1) |
| Provided | 91.16% | 90.44% | 88.13% | 89.33% | 90.06% |
| CopyRNeRF of | | | | | |
| the present | | | | | |
| invention | | | | | |
| HiDDen + NeRF | 50.19% | 49.84% | 50.12% | 50.09% | 50.16% |
| MBRS + NeRF | 50.53% | 51.00% | 51.03% | 50.12% | 50.41% |
| NeRF with | 52.22% | 50.53% | 50.22% | 50.19% | 51.34% |
| message | | | | | |
| CopyNeRf in | 60.16% | 58.00% | 56.94% | 60.09% | 59.38% |
| geometry | | | | | |
| CopyNeRf W/o | 91.25% | 89.12% | 75.81% | 87.44% | 87.06% |
| DRR | | | | | |

It can be seen that the provided method is quite robust to different 2D distortions. Specifically, CopyRNeRF w/o DRR achieves similar performance to the complete CopyRNeRF when no distortion is encountered. However, when it comes to different distortions, its lower bit accuracies demonstrate the effectiveness of our distortion-resistant rendering during training.

### Analysis for Feature Field

In this section, the effectiveness of color feature field and message feature field is further evaluated. It is first to remove the module for building color feature field and directly combine the color representation with the message features. In this case, the model performs poorly in preserving the visual quality of the rendered results. It is to further remove the module for building message feature field and combine the message directly with the color feature field. The results in Table 4 indicate that this may result in lower bit accuracy, which proves that messages are not embedded effectively.

TABLE 4
Comparisons for the provided full model, the provided model
without Message Feature Field (MFF) and the provided model
without Color Feature Field (CFF); the last row shows that
the provided method achieves consistent performance even when
different rendering scheme (DRS) is applied during testing.

| | Bit Acc↑ | PSNR↑ | SSIM↑ | LPIPS↓ |
|---|---|---|---|---|
| Provided | 100% | 32.68 | 0.948 | 0.048 |
| method | | | | |
| W/o MFF | 82.69% | 20.46 | 0.552 | 0.285 |
| W/o CFF | 80.69% | 21.06 | 0.612 | 0.187 |
| DRS | 100% | 32.17 | 0.947 | 0.052 |

### Model Robustness on Rendering

Although a normal volume rendering strategy is applied for inference, the messages can also be effectively extracted using a distortion rendering utilized in training phase. As shown in the last row of Table 4, the quantitative values with the distortion rendering are still similar to original results in the first row of Table 4, which further confirms the robustness of the provided method.

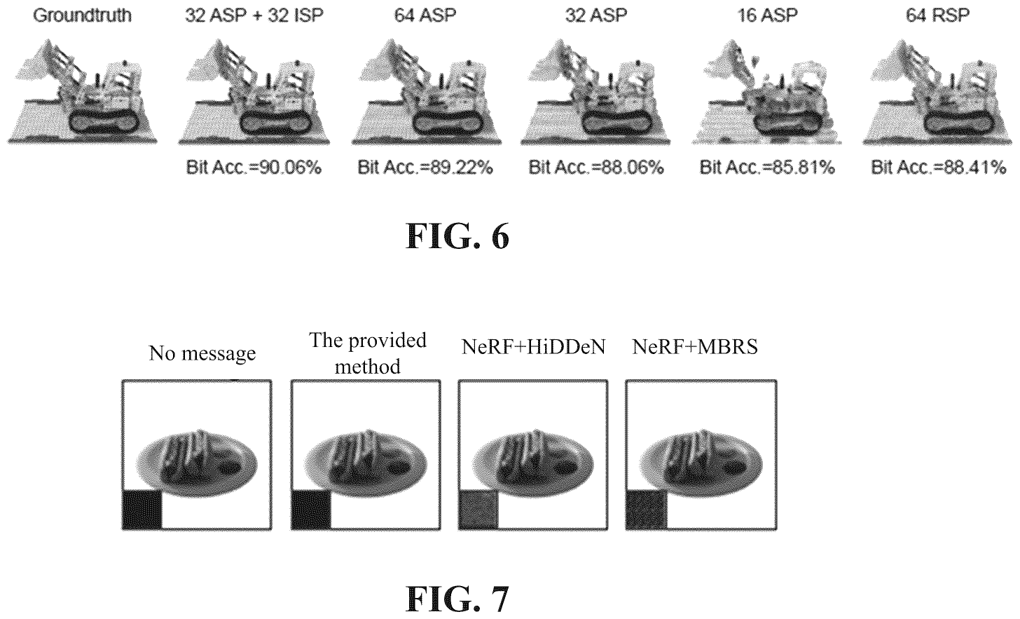

The results for different sampling schemes are further presented in FIG. 6, showing comparisons for different rendering degradation in the inference phase. The message length is set to 16. The applied are average sampling points (ASP), importance sampling points (ISP), and random sampling points (RSP) in different rendering strategies. “32 ASP+32 ISP” is a strategy employed in the training process, and message extraction also shows the highest bit accuracy. When sampling strategies are changed to other ones during inference, the message extraction still shows similar performance, which verifies the effectiveness of our distortion-resistant rendering. The provided distortion-resistant rendering employs 32 average sampling points and 32 importance sampling points during training. When different sampling strategies are applied in the inference phase, the provided method can also achieve high bit accuracy, which can validate the robustness of the provided method referring to different sampling strategies.

Comparison with NeRF+HiDDeN/MBRS

An experiment is also conducted to compare the method with approaches by directly applying 2D watermarking method on rendered images, namely NeRF+HIDDEN and NeRF+MBRS. Although these methods can reach a high bit accuracy as reported in their studies, as shown in FIG. 7. In FIG. 7, there are comparisons for watermarking after rendering; the patch in the lower left corner shows the augmentation result by simply multiplying a factor 30. Image inversion is used for better visualization. These methods can easily leave detectable traces especially in areas with lower geometry values, as they lack the consideration for 3D information during watermarking. Besides, they only consider the media in 2D domain and cannot protect the NeRF model weights.

There are more supplementary passages as below.

### Supplement: Uniqueness of the Provided Method

As well as the provided CopyRNeRF, several strategies are discussed for protecting the copyright of implicit scene representation constructed by NeRF in the present disclosure: (1) directly build an implicit representation using watermarked 2D images; and (2) watermark the representation by using the copyright message as a part of the input. Besides their limitations discussed in our main paper. For (1), if the copyright message is to be changed, the whole representation needs to be trained again, which is time-consuming. Another setting in this document is additionally discussed: why not directly watermark the synthesized 2D images with novel viewpoints?

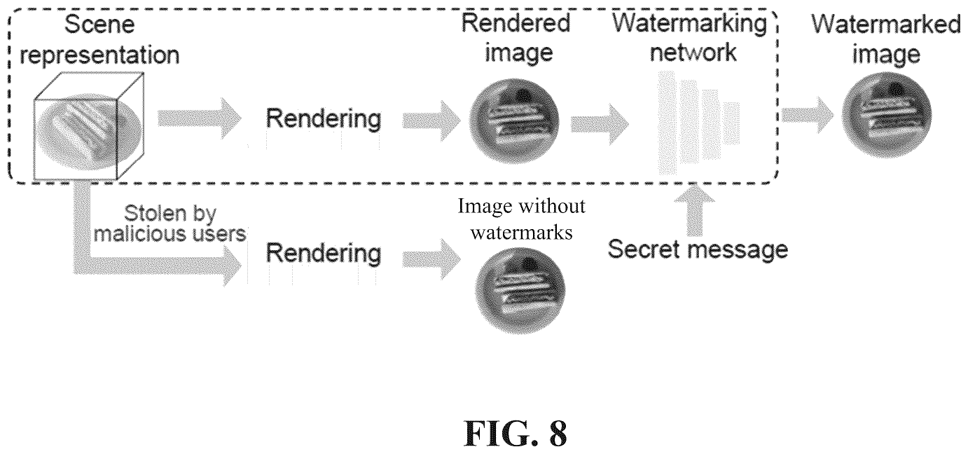

To explain, FIG. 8 shows that when directly watermarking the synthesized 2D images with novel views, the model weights are not protected. Anyone who stoles the 3D representation may generate 2D images without watermarks by skipping the watermarking network. Such setting does not protect the model itself. When the model is stolen by malicious users, the unwatermarked rendering images can be easily generated from the stolen model. Instead, with the provided watermarked color representation and distortion-resistance rendering of the present invention, the model weights are protected. If malicious users produce images by different rendering strategies, the copyright of the provided model of the present invention can still be protected.

### Supplement: Workflow of CopyRNeRF

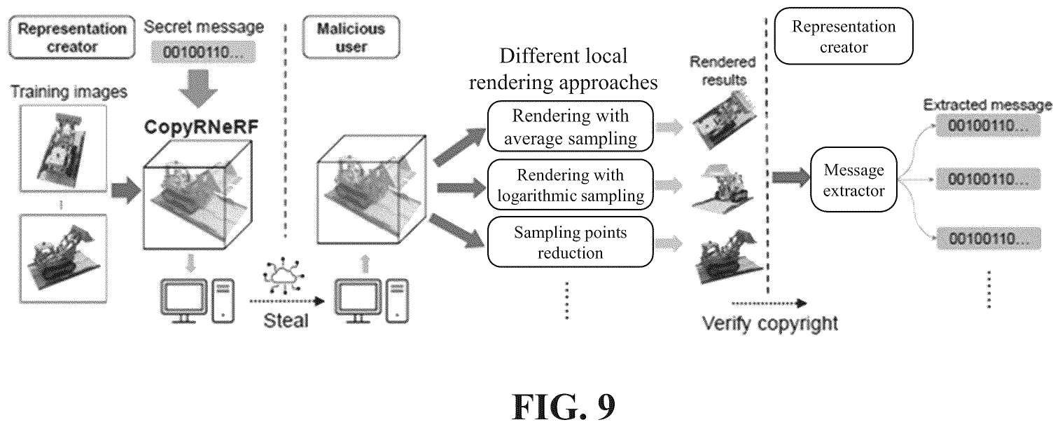

More details about the workflow of the provided CopyRNeRF is introduced. A more concise diagram is illustrated in FIG. 9 depicting workflow of the provided CopyRNeRF. The creator applies CopyRNeRF to generate a core model from a set of 2D images. Even if the model is stolen and different rendering approaches are applied, the model creator can still use the message extractor to reveal the message from the rendered results to verify the copyright. The representation creator can create the implicit representation based on our descriptions in the main paper. Then, as outlined in FIG. 9, the copyright of core model is protected by watermarking messages. Although malicious users can synthesize images with novel viewpoints by applying different rendering approaches to the core model, our method can still ensure that all synthesized images with novel viewpoints are watermarked. Moreover, the trained message extractor can be directly applied to reveal the message from the synthesized images, even when different rendering strategies, distortions, and viewpoints are encountered.

### Supplement: Additional Results

### Additional Results—Visual Results for CopyRNeRF:

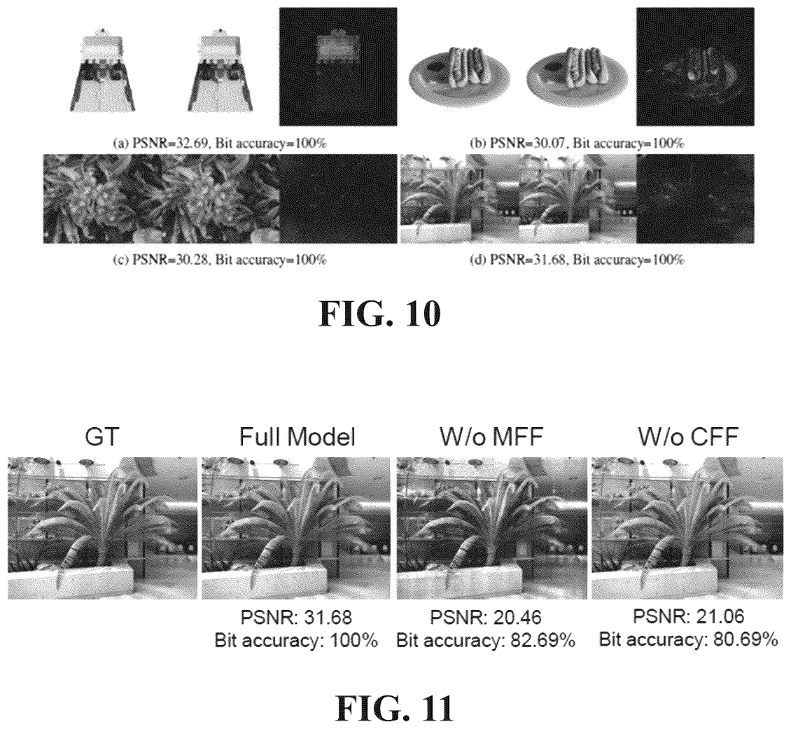

More qualitative results are presented on Blender dataset and LLFF dataset, as shown in FIG. 10. The provided method clearly reaches a high bit accuracy while maintaining the high-quality novel view synthesis. In FIG. 10, additional visual results of different scenes are shown. The message length is set to 8. The illustration shows the differences between the synthesized results and the ground truth from multi-views. From left to right: ground truth, CopyRNeRF, difference (×10).

### Additional Results—Qualitative Results for Table 4:

Effectiveness of message feature field and color feature field of CopyRNeRF have been discussed. The further step is to provide the qualitative evaluations in FIG. 11. In illustration of FIG. 11, there are visual quality comparisons for the provided full model, the provided model without Message Feature Field (MFF) and the provided model without Color Feature Field (CFF). The first is to remove the color feature field and directly combine the color component with the message features, and then remove the message feature field and combine the message directly with the color feature field. In both cases, the models perform poorly in preserving the visual quality of the rendered results.

### Additional Results—Quantitative Results for More Bit Lengths:

results for more lengths of raw bits are displayed. The results of bit accuracy and reconstruction quality for 8 bits, 16 bits, 32 bits, and 48 bits are shown in Table 1, Table 2, Table 3, and Table 4, respectively.

As discussed above, a framework is provided to create a copyright-embedded 3D implicit representation by embedding messages into model weights. In order to guarantee the invisibility of embedded information, the geometry is kept unchanged and a watermarked color representation is constructed to produce the message embedded color. The embedded message can be extracted by a CNN-based extractor from rendered images from any viewpoints, while keeping high reconstruction quality. Additionally, a distortion-resistant rendering scheme is introduced to enhance the robustness of our model under different types of distortion, including classical 2D degradation and different rendering strategies. The proposed method achieves a promising balance between bit accuracy and high visual quality in experimental evaluations.

The functional units and modules of the apparatuses and methods in accordance with the embodiments disclosed herein may be implemented using computing devices, computer processors, or electronic circuitries including but not limited to application specific integrated circuits (ASIC), field programmable gate arrays (FPGA), microcontrollers, and other programmable logic devices configured or programmed according to the teachings of the present disclosure. Computer instructions or software codes running in the computing devices, computer processors, or programmable logic devices can readily be prepared by practitioners skilled in the software or electronic art based on the teachings of the present disclosure.

All or portions of the methods in accordance with the embodiments may be executed in one or more computing devices including server computers, personal computers, laptop computers, mobile computing devices such as smartphones and tablet computers.

The embodiments may include computer storage media, transient and non-transient memory devices having computer instructions or software codes stored therein, which can be used to program or configure the computing devices, computer processors, or electronic circuitries to perform any of the processes of the present invention. The storage media, transient and non-transient memory devices can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Each of the functional units and modules in accordance with various embodiments also may be implemented in distributed computing environments and/or Cloud computing environments, wherein the whole or portions of machine instructions are executed in distributed fashion by one or more processing devices interconnected by a communication network, such as an intranet, Wide Area Network (WAN), Local Area Network (LAN), the Internet, and other forms of data transmission medium.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

What is claimed is:

1. A system for adding copyright protection to implicit 3D models, comprising:
a first MLP module configured to output a geometry parameter according to a 3D coordinate parameter obtained from a 3D model source;
a second MLP module configured to output a base-colors parameter according to a viewing-directions parameter obtained from the 3D model source and according to outcomes of the first MLP module;
a color feature encoder configured to concatenate the geometry parameter, the viewing-directions parameter, and the base-colors parameter to obtain a spatial descriptor and further configured to transform the spatial descriptor to a high-dimensional color feature field;
a message feature encoder configured to map messages to higher dimensions so as to obtain a message feature field; and
a feature fusion module configured to generate a watermarked color representation and embed the watermarked color representation into the 3D model source.

2. The system of claim 1, wherein the feature fusion module is further configured to employ the base-colors parameter, and the watermarked color representation and the base-colors parameter have the same dimension.

3. The system of claim 1, further comprising:
a message extractor comprising a CNN-based network and configured to reveal the message from 2D rendered images in the 3D model source.

4. The system of claim 3, wherein the message extractor employs a sequence of 2D convolutional layers with batch normalization and ReLU functions, and the message extractor incorporates average pooling and a final linear layer with a fixed output dimension, which corresponds to the length of the message, so as to produce a continuous predicted message.

5. The system of claim 1, further comprising:
a rendering module configured to query the watermarked color representation and the geometry parameter for making at least one rendering operator applied to generation for the watermarked color representation in rendered images.

6. The system of claim 5, wherein the rendering module utilizes patch-level rendering and is further configured to crop a window from an image of the 3D model source at a random position and to uniformly sample pixels from the window to create a smaller patch.

7. The system of claim 1, wherein the feature fusion module is further configured to incorporate spatial information into the watermarked color representation, such that the messages embedded in the watermarked color representation remains consistent across different viewpoints rendered from the 3D model source.

8. The system of claim 1, further comprising a display configured display the 3D model sources without embedding the watermarked color representation and with embedding the watermarked color representation.

9. A method for adding copyright protection to implicit 3D models, comprising:
generating, by a first MLP module, a geometry parameter according to a 3D coordinate parameter obtained from a 3D model source;
generating, by a second MLP module, a base-colors parameter according to a viewing-directions parameter obtained from the 3D model source and according to outcomes of the first MLP module;
concatenating, by a color feature encoder, the geometry parameter, the viewing-directions parameter, and the base-colors parameter to obtain a spatial descriptor;
transforming, by the color feature encoder, the spatial descriptor to a high-dimensional color feature field;
mapping, by a message feature encoder, messages to higher dimensions so as to obtain a message feature field; and
generating a watermarked color representation and embedding the watermarked color representation into the 3D model source by a feature fusion module.

10. The method of claim 9, wherein the feature fusion module is further configured to employ the base-colors parameter, and the watermarked color representation and the base-colors parameter have the same dimension.

11. The method of claim 9, further comprising:
revealing, by a message extractor comprising a CNN-based network, the message from 2D rendered images in the 3D model source.

12. The method of claim 11, wherein the message extractor employs a sequence of 2D convolutional layers with batch normalization and ReLU functions, and the message extractor incorporates average pooling and a final linear layer with a fixed output dimension, which corresponds to the length of the message, so as to produce a continuous predicted message.

13. The method of claim 9, further comprising:
querying, by a rendering module, the watermarked color representation and the geometry parameter for making at least one rendering operator applied to generation for the watermarked color representation in rendered images.

14. The method of claim 13, wherein the rendering module utilizes patch-level rendering and crops a window from an image of the 3D model source at a random position and to uniformly sample pixels from the window to create a smaller patch.

15. The method of claim 9, further comprising:
incorporating, by the feature fusion module, spatial information into the watermarked color representation, such that the messages embedded in the watermarked color representation remains consistent across different viewpoints rendered from the 3D model source.

16. The method of claim 9, further comprising displaying, by a display, the 3D model sources without embedding the watermarked color representation and with embedding the watermarked color representation.
